(19) United States
(12) Patent Application Publication
(10) Pub. No.: US 2004/0202755 A1
(43) Pub. Date: Oct. 14, 2004

(54) Speckled confection pieces

(76) Inventors: Gale D. Myers, St. Louis, MO (US); Haralambos N. Meggos, Alton, IL (US)

Correspondence Address: FOLEY & LARDNER, 777 EAST WISCONSIN AVENUE, SUITE 3800, MILWAUKEE, WI, 53202-5308, US

(21) Appl. No.: 10/408,931

(22) Filed: Apr. 8, 2003

(51) Int. Cl. A23L 1/27

(52) U.S. Cl. 426/249

(57) ABSTRACT

Coloring flakes which include a food grade, water soluble polymer component and coloring agents are provided. Also provided are methods for applying the coloring flakes to confection pieces and speckled confection pieces formed with the coloring flakes. The food grade, water soluble polymer may include a food grade, water soluble natural gum. In some embodiments the food grade, water soluble polymer makes up at least 80 weight percent of the coloring flakes. In certain embodiments, the coloring flakes have a size distribution characterized in that at least 90 weight percent of the coloring flakes are retained by a 20 mesh sieve.

### BACKGROUND

Coatings for confectioneries are well known in the industry, including coatings made from natural and synthetic gums, cellulosic polymers and other film forming agents mixed with various pigments and dyes. However, conventional coatings are typically aimed at producing a smooth, uniform, single-color coating on confection pieces. A common method of achieving this is by applying multiple layers of a colored syrup (i.e., an aqueous coloring solution) onto the confection pieces. A much more difficult objective is to provide a decorative, non-uniform, speckled coating on confection pieces. Such traditional coating methods can result in a uniform appearance and cannot be used to provide a speckled appearance. Thus, it may be desirable to have coloring materials containing colored pieces with larger more carefully tailored dimensions to create a decorative speckled appearance. Such colored pieces would desirably have sufficient structural properties to maintain their integrity during a coating process so that they are not reduced to a powder during processing.

Unfortunately, because such coatings can not be easily applied as a solution or a spray, they can present problems with adhesion that are not encountered with traditional coatings. Thus, a need exists for a coloring materials that can provide speckled coloring on confection pieces that do not suffer from the problems associated with inadequate adhesion to the surface, such as peeling or flaking.

### SUMMARY

Coloring flakes for use in the surface treatment of confection pieces and more specifically compositions and methods related to producing confection pieces with speckled coloring are provided. The coloring flakes are typically made from food grade, water soluble polymers, such as natural gums, and coloring agents and, may optionally include other ingredients. Coloring flakes, which may be used to produce a speckled coloring on surfaces of confection pieces, methods for treating or coating confection pieces with the coloring flakes, and speckled colored confection pieces are also provided herein.

The coloring flakes may be made from food grade, water soluble polymer and a coloring agent. The food grade, water soluble polymer commonly includes at least one food grade, water soluble natural gum. In some embodiments, the coloring flakes optionally include a modified cellulose polymer, e.g., in combination with a food grade, water soluble natural gum, such as gum arabic.

The coloring flakes are relatively thin and relatively flat pieces of edible material. Flake thickness may vary depending on such factors as the nature of the confection to be coated and the desired durability of the coating. In certain exemplary embodiments, the coloring flakes will have a thickness of no more than about 15 mils. Suitable embodiments include those where the coloring flakes have a thickness ranging from about 1 mil to 10 mils and further include embodiments where the flakes have a thickness ranging from about 5 mils to about 8 mils. The other flake dimensions may also vary depending on the nature and size of the confection to be colored and the desired degree of speckling. However, the size of the flakes are desirably large enough to provide a non-uniform, speckled appearance, rather than a uniform coating of the type provided by traditional coatings.

Flake size may be characterized by the weight percent (wt. %) of the coloring flakes that are retained by or pass through mesh sieves having specified opening sizes. Typical coloring flakes for use in the present methods include, but are not limited to, coloring flakes in which at least about 90 percent by weight of the coloring flakes in a given distribution will be retained by a 20 mesh sieve, as defined by the U.S. Standard Sieve Series. In other embodiments, at least about 90 percent by weight of the coloring flakes in a sample will be retained by an 8 mesh sieve. For some coatings, it is advantageous if the number of very large flakes in a distribution of coloring flakes is limited. For this reason, in some embodiments no more than about 10 percent by weight of the coloring flakes will be retained by a 4 mesh sieve (i.e., at least about 90 percent by weight of the coloring flakes pass through a 4 mesh sieve).

The present coloring flakes may include flakes of a single color or may include disparately colored flakes. The latter embodiment is particularly suitable for applications where a high degree of speckling is desired.

If natural gum is used to make the coloring flakes, the natural gum may be any food grade, water soluble natural gum. Examples of suitable natural gums include, but are not limited to, gum arabic, kordofan gum, senegal gum, Indian gum, cape gum, gum tragacanth, xanthan gum, furcelleran gum, sterculia gum, gellan gum, guar gum, locust bean gum, and mixtures thereof. The chemical and physical properties of gum arabic make this gum particularly well-suited for use in the present coloring flakes. Since, gum arabic is typically odorless and colorless, its use in coloring flakes generally will not have any substantial effect on either the taste or color of the confection piece. Gum arabic is readily soluble in water, facilitating the preparation of solutions which can be used to form the coloring flakes described herein. Films and flakes formed from gum arabic commonly have good structural integrity. As noted elsewhere herein, gum arabic can be used in combination with a modified cellulose (e.g., hydroxypropyl cellulose and/or hydroxypropyl methylcellulose) where flakes with a higher degree of structural integrity is desired. Gum arabic is also quite versatile. For example, it can be formed into films of varying thickness which still retain desirably properties in terms of integrity, transparency and/or other film properties.

In addition to the naturally occurring gum, the food grade, water soluble polymer may also optionally include a food grade modified cellulose polymer. Suitable food grade modified cellulose polymers include, but are not limited to, methylcellulose, hydroxypropyl cellulose and/or hydroxypropyl methylcellulose.

The coloring agents for use in the coloring flakes commonly include food grade pigments and/or food grade dyes. As used herein, the term “food grade” refers to coloring agents which are suitable for consumption by humans and/or animals. Particularly suitable examples of food grade coloring agents are those which have been approved for use in foods for human consumption by the U.S. Food and Drug Administration or other comparable regulatory body in another country or other jurisdiction.

Specific examples of suitable food grade pigments include FD&C lakes, as well as titanium dioxide. Examples of suitable food grade dyes include both synthetic dyes, such as FD&C dyes, and naturally occurring dyes, such as those derived from extracts of plants. To achieve a desired color tint or shade, the coloring agent may include mixtures of more than one food grade, pigment and/or food grade dye. Illustrative examples of such coloring agents are shown in Tables 1 and 2.

In addition to the food grade, water soluble polymer and the coloring agents, the coloring flakes may include additives such as food grade dispersants, plasticizers, and/or preservatives. Many conventional dispersants, plasticizers and preservatives are known in the art and are commercially available. In some instances, an additive may provide more than one such functional property. For example sodium lauryl sulfate can serve both as a dispersant during preparation of the aqueous coating solution used to form the coloring flakes and as a plasticizer of the polymeric material in the coloring flakes themselves. It may be particularly desirable to include a dispersant in the composition used to form the coloring flakes when the coloring agent in the flakes includes a lake, e.g., an FD&C lake. Examples of suitable dispersants include, but are not limited to, polyoxyethylene sorbitan esters (e.g., polyoxyethylene sorbitan monoesters of fatty acids), lecithins, sodium alkyl sulfates, polyoxyethylene polyoxypropylene block copolymers, or combinations thereof.

The composition of the coloring flakes may vary over a wide range depending on a variety of factors including the nature of the confection to be coated and the desired depth of coloring. In some embodiments, the coloring flakes will include at least about 80 percent by weight of a food grade, water soluble natural gum, such as gum arabic. This includes embodiments where the coloring flakes include at least 90 percent by weight of the food grade, water soluble natural gum. In some embodiments, such as when a significant amount of a modified cellulose polymer is present, a lower amount of the natural gum may be used. For example, in some embodiments, the food grade, water soluble polymer in the coloring flakes may include between about 5 and about 25 percent by weight of the modified cellulose polymers. In other embodiments where flakes with higher levels of structural integrity is desired, the coloring flakes can include from about 40 percent to about 70 percent by weight of a modified cellulose polymer, such as hydroxypropyl methylcellulose. Typically, the coloring agents will make up about 0.1 to about 15 weight percent of the coloring flakes.

The coloring flakes may be made by preparing an aqueous solution of the food grade, water soluble polymer and mixing in the coloring agent and any optional ingredients, such as dispersants, plasticizers, and/or preservatives. An aliquot of the aqueous solution can then be spread across a flat plate or other substrate where it is baked to dryness to form a dried film. This dried film is then shattered and the resulting coloring flakes removed from the plate. In some instances, the dried film may be shattered during the process of its removal from the substrate. If smaller coloring flakes are desired, the coloring flakes recovered from the substrate may be further comminuted (e.g., chopped) to produce coloring flakes of the desired size.

Also provided is a method for preparing speckled confections by wetting a plurality of confection pieces with a aqueous wetting solution to form wetted confection pieces. The wetted confection pieces are contacted with coloring flakes of the type described above, and the flake-treated confection pieces are dried to provide speckled confection pieces. One particularly suitable method of contacting the confection pieces with the coloring flakes is by tumbling the pieces and the flakes together, e.g., by using a revolving coating pan with a tilted base and bumped-in baffles. The confection pieces so coated may be panned confection pieces, that is, confection pieces that are able to withstand the pan tumbling process. Because the sizes of the coloring flakes may be reduced through crushing during the tumbling process or other contacting processes, it is desirable that the initial flake diameter is not too small and the structural integrity of the flakes is sufficient to maintain the dimensions desired after processing. If the coloring flakes are initially too small and/or have insufficient structural integrity, they may be ground into particles during the tumbling process leading to a uniform color coating on the confection rather than the desired speckled appearance.

The aqueous wetting agent may be any food grade wetting agent that facilitates the adhesion of the coloring flakes to the surface of the confection pieces. Sugar syrup is one non-limiting example of a suitable wetting agent for use in the coating process. In other embodiments, the aqueous wetting agent may include a food grade, water soluble polymer.

Once the confection pieces have been treated with the coloring flakes and dried, the process may include the additional step of applying a polishing agent to the speckled confection pieces. The polishing agent can provide a protective barrier around the confection pieces, which can prevent the pieces from sticking together and/or prevent color and candy from rubbing off upon contact. Suitable polishing agents are well known to those in the art and many are commercially available. Examples of suitable polishing agents include food grade, naturally occurring waxes, such as beeswax, carnauba wax, and candelilla wax. Confectioner's glaze is another example of a suitable polishing agent.

### BRIEF DESCRIPTION OF THE DRAWINGS

FIG. 1 shows illustrative speckled confection pieces that have been formed by treating the outer surfaces of panned confection pieces with coloring flakes according to the present method.

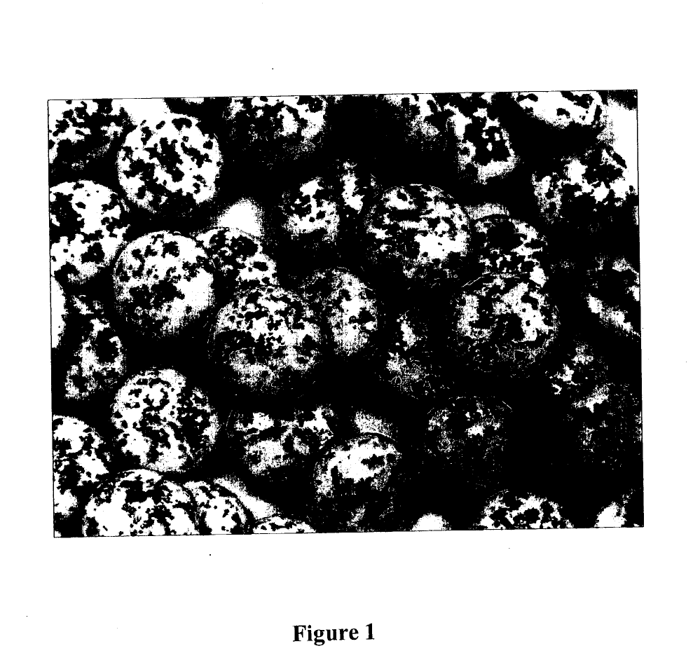

### DETAILED DESCRIPTION

Coloring flakes made from food grade, water soluble polymer and a coloring agent are provided. The food grade, water soluble polymer may include at least one food grade, water soluble natural gum, such as gum arabic. In some embodiments, the coloring flakes may include at least one modified cellulose polymer which may be used in combination with a food grade, water soluble natural gum.

The coloring flakes may be used to provide a speckled surface appearance on confection pieces. Panned confection pieces are a type of confection pieces that may be treated with the coloring flakes. As used herein, the term “panned confection pieces” is used broadly to encompass any confection pieces that are hard enough to be treated by tumbling those pieces in a coating pan, or other similar device, with the desired coating agents. One of skill in the art will appreciate that this definition includes both candy center confection pieces and gum center confection pieces. Although the coloring flakes is described herein primarily for use in surface treatments for confection pieces, it should be noted that the coloring flakes may also be applied to pharmaceutical dosage forms where a decorative surface appearance is desired.

The present coloring flakes are relatively thin and relatively flat pieces of edible material. The size of the flakes should be small enough that a multitude of the flakes may be attached to the outer surface of the confection pieces and large enough to provide a non-uniform, speckled appearance on the outer surface of those confection pieces. Typically, the coloring flakes will have a thickness of no more than about 10 mils, although the present coloring flakes may also be thicker. The dimensions of the flakes in a given distribution of coloring flakes may be characterized by determining what percentage of the flakes are able to pass through mesh sieves having openings with specified diameters. In certain embodiments, the coloring flakes are characterized in that at least 80 weight percent of the coloring flakes would be retained by a 20 mesh sieve. This includes embodiments where at least 90 weight percent of the coloring flakes would be retained by a 20 mesh sieve. For some applications, larger coloring flakes may be desirable. For these applications, suitable coloring flakes would include coloring flakes where about 90 percent by weight of the coloring flakes would be retained by an 8 mesh sieve. In some instances it may be desirable to limit the number of very large flakes in the coloring flake distribution. For these applications, suitable coloring flakes may be characterized in that no more than about 20 percent of the coloring flakes are retained by a 4 mesh sieve. In many instances, no more than about 10 percent of the coloring flakes are retained by a 4 mesh sieve. Alternatively, the size of the coloring flakes may be selected such that no more than about 20 percent of the coloring flakes are retained by a 5 mesh sieve. This includes embodiments wherein no more than about 10 percent of the coloring flakes are retained by a 5 mesh sieve.

The coloring flakes may be flakes of a single color or may include flakes of more than one color. The colors and the relative number of flakes having a given color in a distribution of coloring flakes may be tailored to produce a broad range of speckling patterns and intensities.

Any food grade, water soluble polymer capable of forming a film with adequate structural integrity to produce a flake may be used in the production of the coloring flakes. Such film forming food grade, water soluble polymers are well known. These include, but are not limited to gelatin, pectin, polydextrose, polyvinyl pyrrolidone, maltodextrin, modified celluloses and/or modified starches. Other suitable food grade, water soluble polymers include synthetic and natural gums. Natural gums are particularly suited for use in the coloring flakes.

The natural gums used to produce the coloring flakes may be any food grade, water soluble natural gum. Gum arabic is one specific example of a suitable natural gum. Other examples include, but are not limited to, kordofan gum, senegal gum, Indian gum, cape gum, gum tragacanth, xanthan gum, furcelleran gum, sterculia gum, gellan gum, guar gum, locust bean gum and mixtures thereof.

Food grade, water soluble modified cellulose polymers are another example of a type of film forming polymer that may particularly suitable to be used as a food grade, water soluble polymer in the coloring flakes. Examples of suitable food grade, water soluble modified cellulose polymers include, but are not limited to, methyl cellulose, hydroxypropyl cellulose, and hydroxypropyl methylcellulose. In some embodiments carboxymethyl cellulose and/or hydroxyethyl cellulose may also be used. The modified cellulose polymers may be used in conjunction with other food grade, water soluble polymers, such as natural gums, to enhance the flexibility or structural integrity of the coloring flakes in applications where enhanced flexibility or structural integrity is desirable.

The food grade, water soluble polymer may account for a large part of the coloring flakes. In one embodiment, the food grade, water soluble polymer makes up at least about 80 weight percent of the coloring flakes. This includes embodiments where the food grade, water soluble natural polymer makes up at least about 90 weight percent of coloring flakes. At least a portion of the food grade, water soluble polymer may be a food grade, water soluble natural gum. In some instances it is advantageous to include a significant amount of natural gum in the coloring flakes. In addition to their properties as a film forming material, natural gums and, in particular, gums such as gum arabic, may be considerably more versatile (e.g., in terms of its properties such as water solubility, resultant film integrity and/or ability to be used to form films of varying thickness) than other film forming agents such as cellulosic film formers. In some embodiments the food grade, water soluble polymer is composed entirely of food grade, water soluble natural gums. In other embodiments, the food grade, water soluble polymer includes a substantial amount of natural gum, e.g., at least about 20 weight percent of the total weight of the food grade, water soluble polymer. This includes embodiments where the food grade, water soluble polymer may include at least 40 weight percent natural gum and further includes embodiments where the food grade, water soluble polymer may include at least 70 weight percent natural gum. Commonly, the present coloring flakes include at least about 30 wt. % natural gum and, more suitably at least about 30 wt. % gum arabic. However, the amount of food grade, water soluble natural gum in the coloring flakes may be considerably lower in certain embodiments.

The amount of the modified cellulose polymers used in the production of the coloring flakes, if any, will depend on the desired characteristics of the flakes. In some exemplary embodiments, the modified cellulose polymers may make up between about 5 and about 30 weight percent of the food grade, water soluble polymer. This includes embodiments where the modified cellulose polymers may make up about 10 to about 25 weight percent of food grade, water soluble polymer. In other embodiments, e.g., where flakes with a higher degree of flexibility and/or structural integrity are desired, the modified cellulose polymer may account for about 50 to about 70 weight percent of the food grade, water soluble polymer.

The coloring agents for use in the present coloring flakes may be food grade pigments or dyes or may be a combination of food grade pigments and dyes. The specific pigments and/or dyes and the amount of these pigments and/or dyes that are used to make the coloring flakes will depend on the colors in the desired speckling pattern and the desired color intensity. In a typical embodiment, the coloring agents will make up from about 0.1 to about 15 weight percent of the coloring flakes.

Examples of suitable pigments for use as the coloring agents include food grade lakes. Other suitable pigments can include oxides such as titanium dioxide and iron oxide. The lakes are insoluble pigments which include a soluble dye deposited on an absorptive inorganic substrate, such as metal hydroxide particles. Suitable lakes for use in the coloring flakes include, but are not limited to, lakes of FD&C dyes, e.g., Yellow #6, Yellow #5, Blue #1, Blue #2 and Red #40 lakes. These materials include the corresponding FD&C water soluble dye and fine aluminum hydrate particles. Other examples of lakes which may be employed in the present flakes include lakes of Green #3, amaranth (“Red #2”) and Red #3. Other suitable lakes include lakes of natural water soluble dyes. One example of a lake of a natural dye is carmine, an aluminum lake of carminic acid. Depending on the components of the liquid phase of the aqueous solution of the food grade, water soluble polymer and coloring agent used to form the present flakes, tumeric may function as a pigment, e.g., with aqueous solution which do not include sufficient amounts of organic solvent and/or organic solubilizing agents to substantially dissolve the tumeric. Carbon black is another pigment that may be used in certain embodiments of the present coloring flakes. In many processes commonly used to form the present coloring flakes, the pigments may be added to an aqueous solution of the food grade, water soluble polymers as an aqueous suspension, which may optionally include a dispersant.

The coloring agents employed in forming the present coloring flakes may contain a food grade water soluble dye component. Suitable food grade dyes for use in the present coloring flakes are water soluble dyes which can include both synthetic dyes and natural dyes. These may be added directly to an aqueous solution of the food grade, water soluble polymers. Specific examples of suitable synthetic dyes include, but are not limited to, Yellow #5, Yellow #6, Blue #1, Blue #2, Red #40, Green #3, amaranth and Red #3 (“erythrosine”) dyes, as well as chlorophyll and salts thereof. Vegetable and/or fruit juice concentrates and/or extracts, such as beet concentrate, grape skin extract, and chlorophyll containing extracts (e.g., nettle extract, alfalfa extract and spinach extract) are non-limiting examples of suitable naturally occurring dyes. Other examples of suitable water soluble, natural dyes include carminic acid and caramel.

In addition to the food grade, water soluble polymers and coloring agents, the coloring flakes may include other additives such as food grade dispersants, plasticizers and preservatives. Suitable preservatives include, but are not limited to, methyl and propyl parabens. In some instances a single agent can serve more than one function in the coloring flakes or in the process for making the coloring flakes. For example, sodium lauryl sulfate may act as a dispersant during the preparation of the coloring flakes and as a plasticizer of the polymeric material in the coloring flakes themselves. When pigments are used as the coloring agents, dispersants may be included to aid in dispersing the pigments in an aqueous suspension. Suitable dispersants are well known in the art and are commercially available. Examples of suitable dispersants include, but are not limited to polyoxyethylene sorbitan esters, such as Polysorbate 80 (polyoxyethylene(20) sorbitan monooleate), lecithins, such as soy lecithin, sodium alkyl sulfates, such as sodium lauryl sulfate, polyoxyethylene polyoxypropylene block copolymers, or combinations thereof. Typically, dispersants will make up no more than about 5 weight percent of the coloring flakes and, in many instances are present as about 0.5 to 2 weight percent of the flakes.

Plasticizers, which may be liquid or solid plasticizers, may be used to soften the food grade, water soluble polymers and/or alter other physical properties of the polymeric films. Suitable plasticizers include, but are not limited to, propylene glycol, glycerin, mineral oil, monoglycerides, dibutyl sebecate, acetyltriethylcitrate, acetyltributylcitrate, acetyleted monoglyceride, hydroxylated lecithin. Other suitable plasticizers include lactylated fatty acid esters of propylene glycol (e.g., propylene glycol lactostearate) and glyceryl-lacto esters of fatty acids (e.g., lactated mono-diglycerides). Typically, plasticizers will make up no more than about 10 weight percent of the coloring flakes. In certain embodiments, the plasticizers will make up from about 1 to 6 weight percent of the coloring flakes.

In one embodiment, the present coloring flakes include a food grade, coloring agent and at least about 80 wt. % of a food grade, water soluble, polymer, which includes gum arabic. In many instances the flakes include at least about 75 wt. % gum arabic and commonly have a moisture content of no more than about 15 wt. % (typically about 10 to 13 wt. %). The food grade, coloring agent suitably includes food grade pigment, which often include one or more lakes of a food grade water soluble dye. The water soluble dye may be a synthetic dye and/or a water soluble natural color additive. Lakes of FD&C color additives (i.e., a lake made by extending an FD&C water soluble color on an aluminum substratum) are particularly suitable examples of lakes for use in forming the present coloring flakes. When the coloring agent includes one or more lakes, the aqueous solution, which is used to form the coloring flakes commonly includes a dispersant, e.g., a polyoxyethylene sorbitan ester such as Polysorbate 80. At least about 90 wt. % of the coloring flakes are commonly retained by a 20 mesh sieve. For most applications, the size of the coloring flakes is generally such that no more than about 10 wt. % are retained by a 4 mesh sieve.

A method for producing the present coloring flakes is also provided. The coloring flakes may be made by preparing an aqueous solution of the food grade, water soluble polymer and mixing in the coloring agent and any optional ingredients, such as dispersants, plasticizers, and/or preservatives. An aliquot of the colored aqueous solution can then be spread across a flat substrate where it is dried to remove a substantial amount of the water present, e.g., via baking to dryness to form a dried film. The dried film typically has a moisture content of no more than about 15 wt. %. Moisture contents of about 5 to 15 wt. % are quite suitable and, in many instances, the moisture content of the dried film is about 10 to 13 wt. %.

The dried film is removed from the flat substrate and comminuted to form flakes of the desired size. For example, the dried film may be shattered into a plurality of flakes. In some instances, the dried film may be shattered during the process of its removal from the substrate. If smaller coloring flakes are desired, the coloring flakes as recovered from the substrate may be further comminuted (e.g., chopped) to produce coloring flakes of the desired size. As indicated herein, the resulting flakes commonly have a thickness of about 5 to 10 mils (circa 125 to 250 microns) and a largest dimension of at least about 25 mils (circa 600 microns). For some applications it may be desirable to use coloring flakes which are somewhat larger. For most applications, however, the largest dimension of the majority of the flakes is no more than about 200 to 250 mils (circa 5,000 to 6,500 microns). These larger flakes may still generally have a thickness of no more than about 15 mils and flake thicknesses of about 5 to 10 mils are quite common for such larger flakes.

A method for preparing speckled confections using coloring flakes of the type described above is also provided. The method includes the steps of wetting a plurality of confection pieces with a wetting solution, contacting the wetted confection pieces with a plurality of coloring flakes, and allowing the flake-treated confection pieces to dry. The flake-treated confection pieces are commonly allowed to dry at least until the pieces are dry to the touch. The drying operation can be carried out simply by allowing the treated confection pieces to be exposed to ambient air or, if desired, the treated confection pieces may be exposed to air at a somewhat higher temperature, e.g., about 40 to 60° C. air.

One suitable method of contacting the confection pieces with the coloring flakes is tumbling the confection pieces and the coloring flakes together in a coating pan (or other similar device), also known as pan coating. It should be noted that the exemplary mesh-characterized flake sizes provided above refer to the flake sizes prior to contacting the coloring flakes with the confection pieces. This is because the flake size may be reduced during contacting processes, such as tumbling the flakes with the wetted confection pieces, where the flakes may be crushed by the confection pieces. For this reason, it is generally desirable that the initial flake size is not too small or the structural integrity of the flakes is not too weak. Small or flimsy coloring flakes may be crushed into particles during the tumbling process. This can lead to a uniformly colored surface appearance rather than the desired speckled appearance.

Both aqueous and non-aqueous wetting agents may be employed. However, aqueous wetting agents are advantageous because they can promote adhesion and resist flaking. The wetting agent may itself include one or more food grade, water soluble polymers. Sugar syrup is one example of a suitable aqueous wetting agent for use in the treatment of the confection pieces. However, any aqueous food grade wetting agent that is able to promote the adhesion of the coloring flakes to the surface of the confection pieces may be used. Care should generally be taken, however, to ensure that the wetting agent does not have any opacifying qualities. The amount of the wetting agent which is applied should suitably be sufficient to wet the outer surfaces of the confection pieces without substantially dissolving the outer surface.

Once the coloring flakes have been applied to the surface of the confection pieces, the treatment of the confection pieces may further include the step of applying a polishing agent over the coloring flake-treated confection pieces. Suitable polishing agents are well-known in the art and are commercially available. Examples of suitable polishing agents include, but are not limited to, beeswax, carnauba wax, candelilla wax, confectioner's glaze and combinations thereof. The waxes provide a high gloss to the confection pieces while the confectioner's glaze provides superior barrier properties. The polishing agents may be directly added to the coating pan once the coloring flakes have been applied to the confection pieces and dried. Alternatively, the polishing agents may be applied to the confection pieces using a separate pan dedicated to the polishing process.

### EXAMPLES

Exemplary embodiments of the present coloring flakes and speckled confections are provided in the following examples. The following examples are presented to illustrate the present coloring flakes, methods and speckled confections and to assist one of ordinary skill in making and using the same. The examples are not intended in any way to otherwise limit the scope of the invention.

### Example 1

### Preparation of Coloring Flakes

This example describes a method for producing coloring flakes from gum arabic and various food grade pigments and dyes. Several illustrative formulations (in weight percent) and colors for these coloring flakes are shown in Table 1. The coloring flakes may be prepared as follows. An aqueous solution of a spray dried powder of gum arabic, any optional plasticizer, and purified water is prepared. The solution is then set aside for several hours to allow, any dissolved air to dissipate. The food grade coloring agents, along with any optional dispersant, can be added to the solution while mixing under high shear, such as in a ¼ hp high-speed dispersator. The food grade water soluble dyes may be added directly to the aqueous polymer solution. The food grade pigments are added in the form of an aqueous suspension. An aliquot of the resulting mixture is placed on the top of a 12″×12″ stainless steel plate using a disposable laboratory pipette. The aliquot is then drawn across the plate using a 0.012-inch stainless steel drawdown bar yielding a 12 mil film thickness on the plate. Film thickness can be modified by using different gauge drawdown bars. The coated plate is placed in a standard baking oven at approximately 250° F. (121° C.) for between about 10 and about 15 minutes. Once the coatings are dry, they are shattered and the flakes are removed from the plate using a sharp-edged razor blade. Each 12″×12″ plate produces approximately 1 to 2 grams of the coloring flakes (e.g., flakes with a weight of about 1 to 2 mg per cm²; where the area refers to the area of one side of the flakes). Typically, at least about 90 weight percent of the flakes are large enough to be retained by a 20 mesh sieve.

TABLE 1
Formulations for Coloring Flakes With Gum Arabic

| | RED | BLACK | GRAY | PURPLE | ORANGE | GOLD |
|---|---|---|---|---|---|---|
| Purified Water | 59.16 | 55.76 | 58.80 | 56.37 | 59.85 | 57.34 |
| Gum Arabic | 39.44 | 37.20 | 39.20 | 37.60 | 39.90 | 39.80 |
| FD&C Red #40 Dye | 0.40 | 4.10 | | | | |
| FD&C Red #40 Lake | | | 0.05 | | | 0.14 |
| FD&C Blue #1 Dye | | 1.72 | | 0.03 | | |
| FD&C Blue #1 Lake | | | | | | 0.01 |
| FD&C Blue #2 Lake | | | 0.29 | | | 0.08 |
| FD&C Yellow #5 Dye | | 1.22 | | | | 0.15 |
| FD&C Yellow #5 Lake | | | | | | 0.30 |
| FD&C Yellow #6 Dye | | | | | 0.25 | 0.15 |
| FD&C Yellow #6 Lake | | | 0.16 | | | 0.03 |
| Red Beet Concentrate (Natural Dye) | | | | 4.00 | | |
| Titanium Dioxide | 1.00 | | 0.50 | 2.00 | | 1.00 |
| Polysorbate 80 (Dispersant) | | | 1.00 | | | 1.00 |
| TOTAL | 100.00 | 100.00 | 100.00 | 100.00 | 100.00 | 100.00 |

### Example 2

### Preparation of Coloring Flakes

This example describes a method for producing coloring flakes from gum arabic, modified cellulosic polymers, and various food grade pigments and dyes. Several illustrative formulations (in weight percent) and colors for these coloring flakes are shown in Table 2. The coloring flakes are made in according to the procedure described in Example 1 above, with the exception that the initial aqueous solution is prepared from a combination of a modified cellulose polymers and a spray dried powder of gum arabic.

TABLE 2
Formulations for Coloring Flakes With
Gum Arabic/Modified Cellulose Polymers

| | | Green | | Pink | | Blue |
|---|---|---|---|---|---|---|
| | GREEN | (Dry Basis) | PINK | (Dry Basis) | BLUE | (Dry Basis) |
| Purified Water | 59.64 | | 55.68 | | 58.79 | |
| Gum Arabic | 29.76 | 73.74 | 22.12 | 56.25 | 19.86 | 49.39 |
| Hydroxypropyl methylcellulose | 10.00 | 24.78 | | | | |
| Hydroxypropyl cellulose | | | 15.00 | 38.15 | | |
| Methylcellulose | | | | | 20.00 | 49.74 |
| FD&C Blue #1 Dye | 0.30 | 0.74 | | | 0.05 | 0.12 |
| FD&C Blue #1 Lake | | | | | 0.30 | 0.75 |
| FD&C Yellow #5 Dye | 0.30 | 0.74 | | | | |
| FD&C Red #3 Dye | | | 0.20 | 0.51 | | |
| Titanium Dioxide | | | 2.00 | 5.09 | | |
| Polysorbate 80 (Dispersant) | | | | | 1.00 | |
| Propylene Glycol (Plasticizer) | | | 5.00 | | | |
| TOTAL | 100.00 | 100.00 | 100.00 | 100.00 | 100.00 | 100.00 |

### Example 3

### Preparation of Speckled Confection Pieces

Speckled confections can be prepared from the coloring flakes made according to the methods described in Example 1 above as follows. Approximately 500 grams of confection pieces are placed in a laboratory model revolving coating pan having a 12-inch diameter stainless steel bowl with a tilted base and 4 bumped-in baffles and an operator's on/off switch. The pan is rotated at 25 to 27 rpm to tumble the confection pieces. Sucrose syrup (3 ml; 67 Brix) is then charged into the pan and tumbled with the confection pieces for approximately 15 to 20 seconds until all of the confection pieces in the pan have been wetted by the syrup. Next, coloring flakes (2.5 grams) are added to the pan and tumbled with the confection pieces for approximately 15 to 20 seconds until the coloring flakes have been distributed over the confection pieces. The flake-treated confection pieces are allowed to dry in ambient air (approximately 25° to 30° C.) until all of the pieces are dry to the touch. This typically requires about 2.5 to 3 minutes. The speckled colored products may be removed from the pan at this point or a coating of a polishing agent may be applied to the speckled product.

The invention has been described with reference to various specific and illustrative embodiments and techniques. However, it should be understood that many variations and modifications may be made while remaining within the spirit and scope of the invention.

What is claimed is:

1. A method for preparing speckled confection pieces, the method comprising:
(a) wetting the confection pieces with an aqueous wetting solution to form wetted confection pieces;
(b) contacting the wetted confection pieces with a plurality of coloring flakes to form flake-treated confection pieces; and
(c) drying the flake-treated confection pieces to provide speckled confection pieces;
wherein the coloring flakes comprise food grade, water soluble polymer, which includes food grade, water soluble, natural gum, and a coloring agent, which includes food grade pigment; and at least about 90 wt. % of the coloring flakes are retained by a 20 mesh sieve.

2. The method of claim 1 wherein at least about 90 wt. % of the coloring flakes are retained by a 8 mesh sieve.

3. The method of claim 1 wherein at least about 90 wt. % of the coloring flakes are not retained by a 4 mesh sieve.

4. The method of claim 1 wherein the coloring flakes comprise at least about 80 wt. % of the food grade, water soluble, natural gum and from about 0.1 to about 15 wt. % of the coloring agent.

5. The method of claim 1 wherein the food grade, water soluble, natural gum comprises gum arabic.

6. The method of claim 1 wherein the comprise food grade, water soluble polymer further comprises modified cellulose polymer.

7. The method of claim 1 wherein the modified cellulose polymer comprises methylcellulose, hydroxypropyl cellulose, hydroxypropyl methylcellulose, or a mixtures thereof.

8. The method of claim 1 wherein the food grade pigment includes one or more food grade color lakes.

9. The method of claim 1 wherein the food grade pigment includes one or more inorganic oxides.

10. The method of claim 1 wherein the food grade pigment includes tumeric.

11. The method of claim 1 wherein the coloring agent further comprises one or more food grade, water soluble dyes.

12. The method of claim 1 wherein the aqueous wetting solution comprises sugar.

13. The method of claim 1 further comprising applying a coating of a polishing agent over the speckled confection pieces.

14. A method for preparing speckled confection pieces, the method comprising:
(a) wetting the confection pieces with an aqueous wetting solution to form wetted confection pieces;
(b) contacting the wetted confection pieces with a plurality of coloring flakes to form flake-treated confection pieces; and
(c) drying the flake-treated confection pieces to provide speckled confection pieces;
wherein the coloring flakes comprise a food grade pigment component and at least about 80 wt. % of a food grade, water soluble polymer which includes gum arabic.

15. The method of claim 14 wherein the coloring flakes comprise at least about 80 wt. % gum arabic.

16. The method of claim 14 wherein the food grade, water soluble polymer further comprises a modified cellulose polymer.

17. The method of claim 14 wherein the food grade pigment component comprises pigments selected from the group consisting of FD&C lakes, lakes of food grade, water soluble natural colors, and mixtures thereof.

18. The method of claim 14 wherein the food grade pigment component comprises titanium dioxide.

19. The method of claim 14 wherein the coloring flakes further comprise a food grade, water soluble dye.

20. The method of claim 19 wherein the food grade, water soluble dye comprises at least one FD&C dye.

21. The method of claim 19 wherein the food grade, water soluble dye comprises at least one food grade, water soluble natural color.

22. Coloring flakes comprising at least about 80 wt. % of a food grade, water soluble, polymer, which includes gum arabic, and about 0.1 to about 15 wt. % of a food grade, coloring agent, which includes food grade pigment; wherein at least about 90 wt. % of the coloring flakes are retained by a 20 mesh sieve.

23. The coloring flakes of claim 22 comprising at least about 80 wt. % gum arabic.

24. The coloring flakes of claim 22, wherein the food grade, coloring agent which includes one or more pigments selected from the group consisting of FD&C lakes and lakes of food grade, water soluble natural colors.

25. The coloring flakes of claim 22, wherein the food grade, water soluble, polymer further comprises modified cellulose.

26. The coloring flakes of claim 22 comprising at least about 75 wt. % gum arabic; and further comprising a dispersant; wherein the food grade pigment includes at least one FD&C lake.

27. The coloring flakes of claim 22 wherein the food grade pigment comprises one or more pigments selected from the group consisting of FD&C lakes and titanium dioxide.

28. The coloring flakes of claim 22 wherein the coloring agent further comprise a food grade, water soluble dye.

29. The coloring flakes of claim 22 further comprising dispersant.

30. The coloring flakes of claim 29, wherein the dispersant comprises polyoxyethylene sorbitan ester, lecithin, sodium alkyl sulfate, polyoxyethylene polyoxypropylene block copolymer, or a combination thereof.

31. The coloring flakes of claim 22 comprising about 50 to about 75 percent by weight of a food grade, water soluble, natural gum, and about 25 to about 50 weight percent of at least one modified cellulose.

32. Speckled confection pieces comprising an outer surface having a plurality of coloring flakes disposed thereon;
wherein the coloring flakes comprise at least about 80 wt. % of a food grade, water soluble, polymer, which includes gum arabic, and about 0.1 to about 15 wt. % of a coloring agent, which includes food grade pigment.

33. The speckled confection pieces of claim 32 wherein the coloring flakes include flakes of more than one color.

34. The speckled confection pieces of claim 32 further comprising a coating, which includes polishing agent, disposed over the coloring flakes.

35. Speckled confection pieces formed by a process comprising the steps of:
(a) wetting confection pieces with an aqueous wetting solution to form wetted confection pieces;
(b) contacting the wetted confection pieces with a plurality of coloring flakes to form flake-treated confection pieces; and
(c) drying the flake-treated confection pieces to provide speckled confection pieces;
wherein the coloring flakes comprise (a) food grade, water soluble polymer, which includes food grade, water soluble, natural gum, and (b) a coloring agent, which includes food grade pigment; and at least about 90 wt. % of the coloring flakes are retained by a 20 mesh sieve.
